(19) United States
(12) Patent Application Publication
(10) Pub. No.: US 2019/0064720 A1
(43) Pub. Date: Feb. 28, 2019

(54) PRINTING APPARATUS AND CONTROL METHOD OF PRINTING APPARATUS

(71) Applicant: SEIKO EPSON CORPORATION, Tokyo (JP)

(72) Inventor: Ryu KAMEI, Matsumoto-shi (JP)

(21) Appl. No.: 16/114,573

(22) Filed: Aug. 28, 2018

(30) Foreign Application Priority Data
Aug. 30, 2017 (JP) 2017-165608

(51) Int. Cl. G03G 15/00; H04N 1/00

(52) U.S. Cl. CPC G03G 15/5037; G03G 15/607; H04N 1/00687; H04N 1/00602; G03G 15/602

(57) ABSTRACT

A printing apparatus includes a transport mechanism for transporting a transport roll paper, a first slack detection sensor and a second slack detection sensor, or a label detection sensor driven at a predetermined cycle, a high-pass filter circuit to which detection voltages of the first slack detection sensor and the second slack detection sensor, or the label detection sensor are inputted, and an SOC (control circuit) for determining presence or absence of the transport roll paper or a label attached to a label sheet by comparing a detection voltage that has passed through the high-pass filter circuit with a predetermined threshold value.

This application claims priority under 35 U.S.C. § 119 to Japanese Patent Application No. 2017-165608 filed on Aug. 30, 2017, the entire disclosure of which is expressly incorporated by reference herein.

### BACKGROUND

### 1. Technical Field

The present invention relates to a printing apparatus and a method of controlling a printing apparatus.

### 2. Related Art

In the past, a technique of performing detection on a medium such as detection of presence or absence of a medium and detection of a mark attached to a medium and the like by an optical sensor is known (for example, refer to JP-A-2-228526). In JP-A-2-228526, a technique is disclosed in which, when an average of detection voltages of an optical sensor increases due to disturbance light, the average of detection voltages is reduced with differential amplification by negative feedback of an operational amplifier, and the increase in the average of detection voltages due to the disturbance light is canceled to prevent an influence of disturbance light.

JP-A-2-228526 is based on assumption that, because the average of detection voltages is used, the average of detection voltages of the optical sensor differs depending on presence or absence of the disturbance light, while the average of detection voltages does not differ in detection on a medium. For this reason, in JP-A-2-228526, although it is possible to prevent the influence of disturbance light, it is difficult to accurately perform the detection on a medium using a detection voltage.

### SUMMARY

An advantage of some aspects of the invention is to be capable of accurately performing detection on a medium while preventing an influence of disturbance light.

A printing apparatus according to a working example of the invention includes a transport mechanism for transporting a medium, an optical sensor, a high-pass filter circuit to which a detection voltage of the optical sensor is inputted, and a control circuit that drives the optical sensor at a predetermined cycle and compares an output voltage outputted from the high-pass filter circuit with a predetermined threshold value to determine presence or absence of the medium.

According to the working example of the invention, a detection voltage, effective for determination, of the optical sensor driven at the predetermined cycle capable of passing through the high-pass filter circuit has a high frequency and is capable of passing through the high-pass filter circuit, and disturbance light or the like that adversely affects to the determination has a lower frequency than a frequency capable of passing through the high-pass filter circuit and is not capable of passing through, thus the detection on a medium may be accurately performed while preventing the influence of disturbance light by comparing a detection voltage that has passed with the predetermined threshold value and determining presence or absence of the medium or a mark when the mark is attached to the medium.

Further, a working example of the invention includes an impedance conversion circuit between the high-pass filter circuit and the control circuit.

According to the working example of the invention, since the impedance conversion circuit is included between the high-pass filter circuit and the control circuit, deterioration in noise resistance of a detection voltage that has passed through the high-pass filter circuit may be prevented, and the detection on a medium may be accurately performed.

Further, a working example of the invention includes a voltage stabilizing circuit on an input side of the impedance conversion circuit.

According to the working example of the invention, since the voltage stabilizing circuit is included on the input side of the impedance conversion circuit, it is possible to prevent a detection voltage from being changed due to generation of a leakage current from the input side, and thus it is possible to accurately perform the detection on a medium.

In addition, a working example of the invention includes an amplifier circuit between the impedance conversion circuit and the control circuit.

According to the working example of the invention, since the amplifier circuit is included between the impedance conversion circuit and the control circuit, change in a detection voltage may be made remarkable in the detection on a medium, and the detection on a medium may be performed more accurately.

Further, in a working example of the invention, the medium is a label sheet that is formed by attaching labels to a mount at a predetermined interval, and the control circuit compares the output voltage outputted from the high-pass filter circuit with the predetermined threshold value to determine presence or absence of the label on the mount.

According to the working example of the invention, since the presence or absence of the label on the mount is determined by comparing the detection voltage that has passed through the high-pass filter circuit with the predetermined threshold value, the presence or absence of the label attached to the mount may be accurately detected while preventing the influence of disturbance light.

In addition, according to a working example of the invention, the control circuit compares the output voltage outputted from the high-pass filter circuit with the predetermined threshold value, detects presence or absence of the medium, and controls transport of the medium by the transport mechanism.

According to the working example of the invention, by comparing the detection voltage that has passed through the high-pass filter circuit with the predetermined threshold value to determine presence or absence of a medium such as a roll paper, it is possible to accurately detect the presence or absence of the medium while preventing the influence of disturbance light, thereby accurately controlling the transport of the medium.

Further, a working example of the invention is a method for controlling a printing apparatus including a transport mechanism for transporting a medium, drives an optical sensor at a predetermined cycle, inputs a detection voltage of the optical sensor to a high-pass filter circuit, and compares an output voltage outputted from the high-pass filter circuit with a predetermined threshold value to determine presence or absence of the medium.

According to the working example of the invention, since the optical sensor is driven at the predetermined cycle capable of passing through the high-pass filter circuit, the detection voltage that has passed through the high-pass filter circuit is compared with the predetermined threshold value, and the presence or absence of the medium or a mark, when the mark is attached to the medium, is determined, thus the detection on a medium may be accurately performed while preventing the influence of disturbance light.

### BRIEF DESCRIPTION OF THE DRAWINGS

The invention will be described with reference to the accompanying drawings, wherein like numbers reference like elements.

FIG. 1 is a diagram showing a configuration of a main portion of a printing apparatus.

FIG. 2 is a diagram showing an example of a label sheet.

FIG. 3 is a block diagram showing a control configuration of the printing apparatus.

FIG. 4 is a diagram showing a configuration of a roll paper detection section.

FIG. 5 is a flowchart showing an operation of the printing apparatus.

FIG. 6A is a diagram showing an example of a simulation result.

FIG. 6B is a diagram showing an example of a simulation result.

FIG. 6C is a diagram showing an example of a simulation result.

FIG. 6D is a diagram showing an example of a simulation result.

FIG. 7 is a diagram showing a configuration of a label detection section.

FIG. 8 is a flowchart showing an operation of a printer.

FIG. 9 is a diagram showing a configuration of a roll paper detection section according to a variation.

### DESCRIPTION OF EXEMPLARY EMBODIMENTS

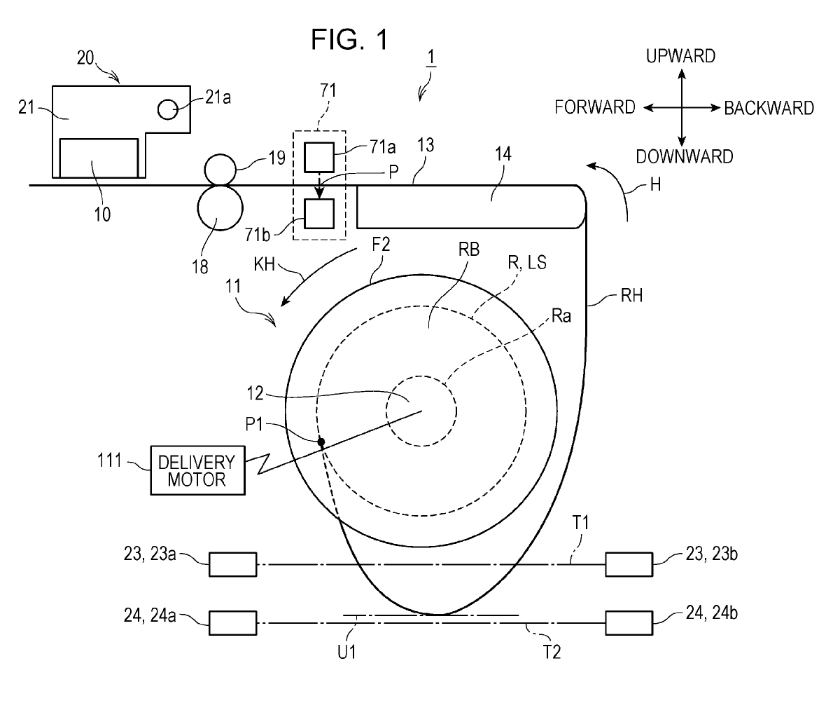

FIG. 1 is a diagram showing a configuration of a main portion of a printing apparatus 1 according to an embodiment.

In the following description with reference to FIG. 1, in each direction indicated by an arrow, a direction toward a left in the figure is defined as “forward”, a direction toward a right in the figure is defined as “backward”, a direction toward a top in the figure is defined as “upward”, and a direction toward a bottom in the figure is defined as “downward”.

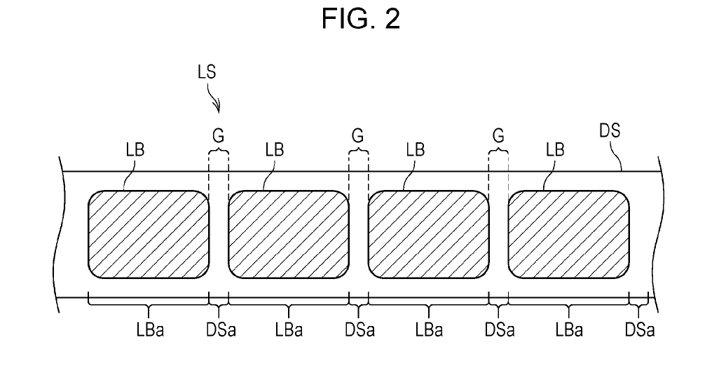

The printing apparatus 1 is a serial ink jet printer, and prints on a print medium (medium) by ejecting ink from an ink jet head 10 configured as a serial head. A mark is attached to the print medium of the embodiment. The mark indicates a sign of a predetermined position attached to the print medium, and also includes a label LB (see FIG. 2) (mark) described later, for example.

As the print medium, the printing apparatus 1 contains a roll paper R that is a rolled label sheet LS (see FIG. 2) that is formed by attaching the labels LB (see FIG. 2) to a mount DS (see FIG. 2) at a predetermined interval, and delivers and transports the roll paper R in a transport direction H. Then, the printing apparatus 1 performs printing by ejecting the ink from the ink jet head 10 to the roll paper R being transported. The roll paper R is a roll around which the label sheet LS is wound, whose end is attached to a core member Ra.

Here, with reference to FIG. 2, the label sheet LS will be described.

FIG. 2 is a diagram showing an example of the label sheet LS.

The label sheet LS includes the long mount DS, and the labels LB attached in a row at a predetermined interval on a surface of the mount DS. A gap G having a constant width is provided between the adjacent labels LB. In the following description, a portion of the label sheet LS on which only the mount DS exists is represented as a mount portion DSa, and a portion that is formed by superimposing the label LB on the mount DS is represented as a label portion LBa.

Note that the mount DS is a release paper that is formed by processing a material such as a resin film or a synthetic paper into a long continuous paper shape having a constant width. The label LB is a label seal made of an opaque material such as white, and a surface of the label LB is subjected to surface processing suitable for a printing method (ink jet type in the embodiment), and a back surface of the label LB is subjected to adhesive processing. Various materials, thicknesses, colors, and the like, are adopted for the mount DS and the label LB depending on an application.

As shown in FIG. 1, the printing apparatus 1 includes a paper containing section 11 that contains the roll paper R. In the following description, a rolled portion of the roll paper R contained in the paper containing section 11 will be referred to as a “roll body RB”. Further, a portion of the roll paper R that is delivered and transported from the roll body RB contained in the paper containing section 11 is referred to as a “transport roll paper RH”.

A roll support section 12 is fitted into the cylindrical core member Ra provided at a central portion of the roll body RB in the paper containing section 11. The roll support section 12 holds the roll body RB via the core member Ra. The roll support section 12 is connected to a motor shaft of a delivery motor 111, which will be described later, via a power transmission mechanism, and rotates in accordance with drive of the delivery motor 111. Thus, in conjunction with rotation of the roll support section 12 in a rotation direction KH, the roll body RB rotates and the transport roll paper RH is delivered from the roll body RB. Thus, transport force to the transport roll paper RH by a transport roller 18 and a driven roller 19 is assisted.

As shown in FIG. 1, a transport path 13 through which the transport roll paper RH is transported is formed in the printing apparatus 1. The transport path 13 includes a guide member 14. The transport roll paper RH delivered from the roll body RB contacts the guide member 14 and is transported along the transport path 13 in the transport direction H.

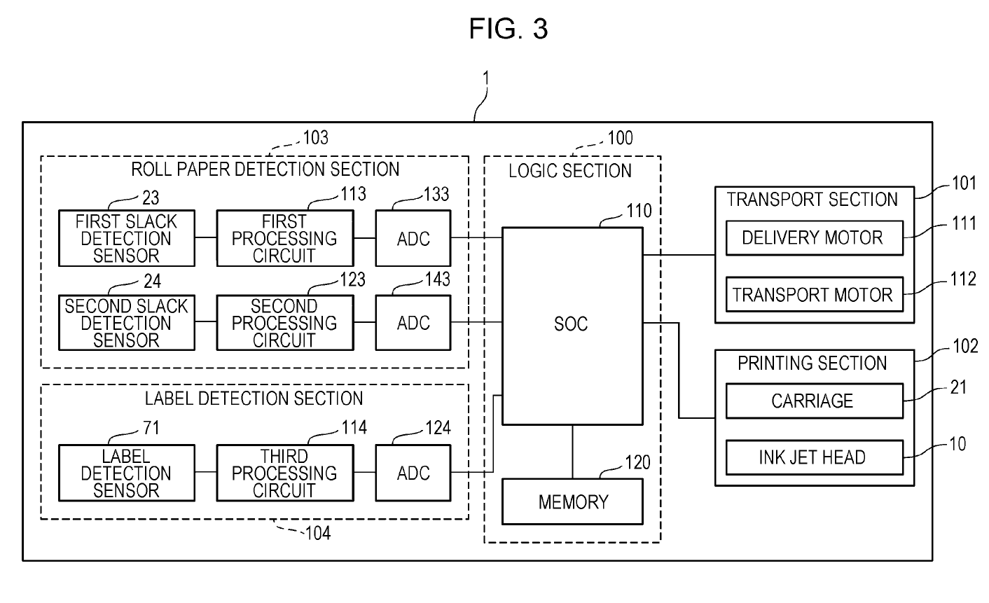

As shown in FIG. 1, a label detection sensor 71 (optical sensor) is included in the printing apparatus 1 on an upstream side in the transport direction H of the transport roller 18 and on a downstream side in the transport direction H of the guide member 14 in the transport path 13. The label detection sensor 71 is an optic type sensor and includes a light emitting sensor 71a disposed above the transport path 13 (in the embodiment, on a side of the ink jet head 10) and a light receiving sensor 71b disposed below the transport path 13. Note that in the label detection sensor 71, the light emitting sensor 71a may be disposed below the transport path 13 and the light receiving sensor 71b may be disposed above the transport path 13. The light emitting sensor 71a is turned on under control of an SOC (System-on-Chip) 110 (control circuit, CPU, processor) (see FIG. 3), and irradiates a detection position P with light. The detection position P is a position on the transport path 13 that is irradiated with light by the light emitting sensor 71a. The light emitted by the light emitting sensor 71a passes through the label sheet LS and is received by the light receiving sensor 71b. At this time, a received light amount by the light receiving sensor 71b changes depending on which of the mount portion DSa and the label portion LBa of the label sheet LS is positioned at the detection position P. A detection voltage by the label detection sensor 71 changes due to this change in the received light amount, and based on this change in the detection voltage, the SOC 110 determines which of the mount portion DSa and the label portion LBa is positioned at the detection position P. In other words, the SOC 110 determines presence or absence of the label LB at the detection position P. The determination of the presence or absence of the label LB corresponds to determination of a mark attached to a print medium.

In the transport path 13, the transport roller 18 is provided on the downstream side in the transport direction H of the label detection sensor 71, and the driven roller 19 is provided at a position corresponding to the transport roller 18. The transport roll paper RH is pinched between the transport roller 18 and the driven roller 19, and is transported in the transport direction H in accordance with rotation of the transport roller 18. The transport roller 18 is connected to a motor shaft of a transport motor 112 (see FIG. 3), which will be described later, via a power transmission mechanism, and rotates in accordance with drive of the transport motor 112.

In the transport path 13, a printing unit (printing mechanism) 20 is provided on the downstream side in the transport direction H of the transport roller 18. The printing unit 20 includes a carriage 21 and the ink jet head 10 mounted on the carriage 21. The carriage 21 is supported by a carriage shaft 21a extending in a scanning direction intersecting with the transport direction H, and scans the ink jet head 10 in the scanning direction along the carriage shaft 21a. The ink jet head 10 includes nozzle rows of a plurality of colors (e.g., four colors of cyan (C), yellow (Y), magenta (M), and black (K)). The ink jet head 10 ejects ink supplied from an ink cartridge from the nozzles provided in each nozzle row to form dots on the transport roll paper RH (more specifically, the label LB) to print characters, images, and the like.

As shown in FIG. 1, a first slack detection sensor 23 is provided below the paper containing section 11 in a vertical direction, and a second slack detection sensor 24 is provided below the first slack detection sensor 23.

The first slack detection sensor 23 (optical sensor) is an optic type sensor, and outputs different detection voltages to the SOC 110 (see FIG. 3) depending on presence or absence of the transport roll paper RH in a detection position T1. The second slack detection sensor 24 (optical sensor) is an optic type sensor, and outputs different detection voltages to the SOC 110 (see FIG. 3) depending on presence or absence of the transport roll paper RH in a detection position T2 below the detection position T1. Processing of the SOC 110 (see FIG. 3) based on input from the first slack detection sensor 23 and the second slack detection sensor 24 will be described later.

FIG. 3 is a block diagram showing a configuration of the printing apparatus 1.

The printing apparatus 1 includes a logic section 100 (logic circuit), a transport section 101 (transport mechanism), a printing section 102 (printing mechanism), a roll paper detection section 103 (roll paper detection circuit), and a label detection section 104 (label detection circuit).

The logic section 100 (logic circuit) includes the SOC 110 and a memory 120.

The SOC 110 is an integrated circuit that controls each section of the printing apparatus 1. The SOC 110 includes a CPU (processor, controller), or the like as an operation execution circuit. A ROM constituting the memory 120 is connected to the SOC 110, and the ROM stores a control program such as firmware executable by the CPU and data related to the control program in a nonvolatile manner. The SOC 110 reads and executes the control program stored in the ROM and controls transport of the roll paper R by the transport section 101 and an operation of printing by the printing section 102 through cooperation of hardware and software, and controls each section of the printing apparatus 1. Further, the SOC 110, by executing the control program stored in the ROM, determines the presence or absence of the transport roll paper RH at the detection position T1 and the detection position T2 (i.e., presence or absence of the roll paper R). Further, the SOC 110 determines the presence or absence of the label LB at the detection position P by executing the control program stored in the ROM.

The memory 120 includes a semiconductor memory element such as an EEPROM, a flash memory or the like, or a storage medium such as a hard disk, and stores various data in a nonvolatile and rewritable manner. Further, the memory 120 stores a medium determination threshold value (predetermined threshold value) for determining the presence or absence of the transport roll paper RH at the detection position T1 and the detection position T2. Further, the memory 120 stores a label determination threshold value (predetermined threshold value) for determining the presence or absence of the label LB at the detection position P.

A mechanism of the printing apparatus 1 is configured with the transport section 101 and the printing section 102. The transport section 101 includes as a mechanism for transporting the roll paper R (transport mechanism), the delivery motor 111, a power transmission mechanism for transmitting power of the delivery motor 111 to the roll support section 12, and a motor driver for driving the delivery motor 111. In accordance with control of the SOC 110, the transport section 101 drives the delivery motor 111 to drive and rotate the roll support section 12 and the core member Ra held by the roll support section 12, and delivers the transport roll paper RH from the roll body RB. Further, the transport section 101 includes as a configuration for transporting the roll paper R, the transport motor 112, a power transmission mechanism for transmitting power of the transport motor 112 to transport roller 18, and a motor driver for driving the transport motor 112. Under control of the SOC 110, the transport section 101 drives the transport motor 112 to rotate the transport roller 18 and transports the transport roll paper RH delivered from the roll body RB.

The printing section 102 includes a mechanism for printing (printing mechanism) such as the ink jet head 10, or the carriage 21, and under control of the SOC 110, forms, by the ink jet head 10, dots on the transport roll paper RH transported by the transport section 101, and prints characters, images, and the like.

The roll paper detection section 103 (roll paper detection circuit) includes the first slack detection sensor 23, a first processing circuit 113, and an A/D (Analog/Digital) converter (hereinafter, referred to as “ADC”) 133. The first slack detection sensor 23 is driven at a predetermined cycle under control of the SOC 110, and inputs an analog detection voltage corresponding to the presence or absence of the transport roll paper RH at the detection position T1 to the first processing circuit 113. Here, a term “drive” refers to at least one of “turn on” and “turn off”. The first processing circuit 113 performs processing to be described later on the inputted analog detection voltage, and inputs the processed detection voltage to the ADC 133. The ADC 133 converts the analog detection voltage processed by the first processing circuit 113 to a digital detection voltage and inputs to the SOC 110.

Further, the roll paper detection section 103 includes the second slack detection sensor 24, a second processing circuit 123, and an ADC 143. The second slack detection sensor 24 is driven at a predetermined cycle under control of the SOC 110, and inputs an analog detection voltage corresponding to the presence or absence of the transport roll paper RH at the detection position T2 to the second processing circuit 123. The second processing circuit 123 performs processing to be described later on the inputted analog detection voltage, and inputs the processed detection voltage to the ADC 143. The ADC 143 converts the analog detection voltage processed by the second processing circuit 123 to a digital detection voltage and inputs to the SOC 110.

The label detection section 104 (label detection circuit) includes the label detection sensor 71, a third processing circuit 114, and an ADC 124. The label detection sensor 71 is driven at a predetermined cycle under control of the SOC 110, and inputs an analog detection voltage corresponding to the presence or absence of the label LB at the detection position P to the third processing circuit 114. The third processing circuit 114 performs processing, for example, amplification, filtering, and the like on the inputted analog detection voltage, and inputs the processed detection voltage to the ADC 124. The ADC 124 converts the analog detection voltage processed by the third processing circuit 114 to a digital detection voltage and inputs to the SOC 110.

Next, processing of the SOC 110 (see FIG. 3) based on input from the first slack detection sensor 23 and the second slack detection sensor 24 will be described.

When a state of the printing apparatus 1 is a state shown in FIG. 1, that is, when a remaining amount of the label sheet LS in the roll body RB is sufficient and the transport roll paper RH can be positioned below the detection position T1, the SOC 110 manages a positional relationship between a lowermost position U1 (refer to FIG. 1) of the transport roll paper RH and the detection position T1 and the detection position T2 in a vertical direction based on a detection voltage inputted from the first slack detection sensor 23 and a detection voltage inputted from the second slack detection sensor 24. The lowermost position U1 is a lowermost position of the transport roll paper RH, in the transport roll paper RH between a delivery position P1 and the guide member 14. Further, the delivery position P1 is a position at which the transport roll paper RH is separated from the roll body RB and delivered to the transport path 13 side in accordance with rotation of the roll support section 12 on circumference of the roll body RB.

The SOC 110, in order to maintain a state in which the lowermost position U1 is positioned vertically lower than the detection position T1 and is positioned vertically higher than the detection position T2, controls the delivery motor 111 of the transport section 101, adjusts a rotation amount of the roll support section 12, and adjusts an amount of delivery of the transport roll paper RH delivered from the roll body RB. In other words, when the SOC 110 determines that the transport roll paper RH is absent at the detection position T1 using the first slack detection sensor 23, the SOC 110 controls the delivery motor 111 of the transport section 101 to rotate the roll support section 12 in the rotation direction KH. Further, when the SOC 110 determines that the transport roll paper RH is present at the detection position T2 using the second slack detection sensor 24, the SOC 110 controls the delivery motor 111 of the transport section 101 to rotate the roll support section 12 in a reverse direction of the rotation direction KH.

When the lowermost position U1 is positioned below the detection position T1 and is positioned above the detection position T2, a slack occurs in the transport roll paper RH as shown in FIG. 1. Thus, a force of pulling the transport roll paper RH acting in a reverse direction of the transport direction H (transport load) generated in the transport roll paper RH is reduced. For this reason, it is possible to suppress occurrence of so-called “empty transport” in which the transport load becomes larger than the transport force to the transport roll paper RH by the transport roller 18 and the driven roller 19, thus the transport roll paper RH can not be transported. Note that, in the embodiment, moving the lowermost position U1 in the vertical direction between the detection position T1 and the detection position T2 also corresponds to transport of the transport roll paper RH.

Thus, the SOC 110 causes the slack in the transport roll paper RH based on the detection voltages inputted from the first slack detection sensor 23 and the second slack detection sensor 24. In the embodiment, the roll paper detection section 103 (particularly, the first processing circuit 113 and the second processing circuit 123) has the following configuration so that the presence or absence of the transport roll paper RH can be accurately detected by the first slack detection sensor 23 and the second slack detection sensor 24.

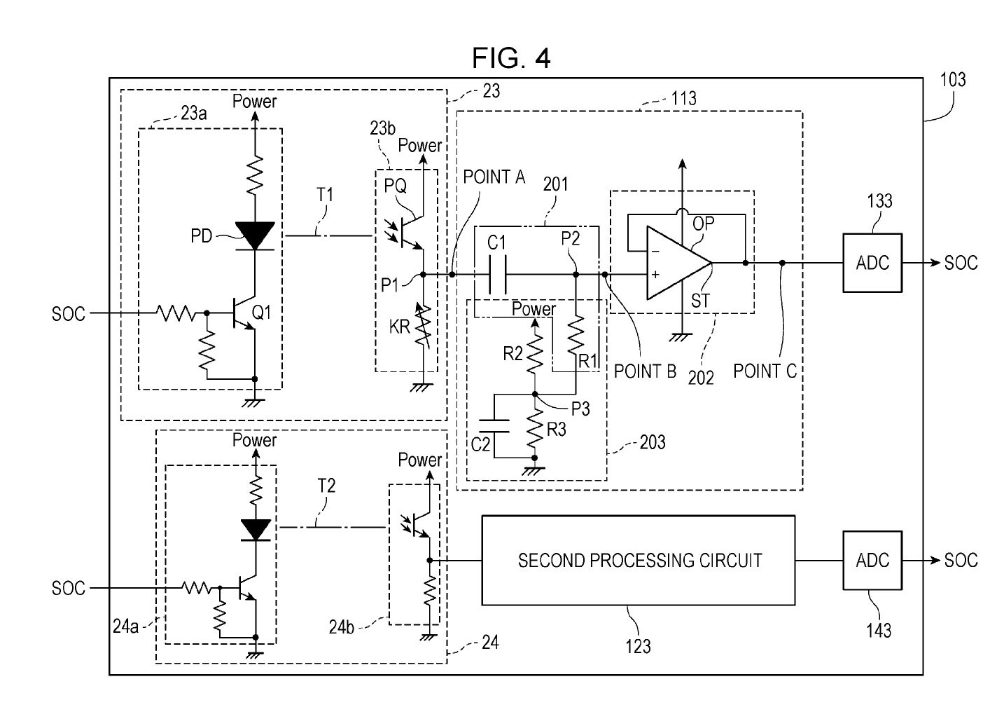

FIG. 4 is a diagram showing a configuration of the roll paper detection section 103.

In the embodiment, the first slack detection sensor 23 and the second slack detection sensor 24 included in the roll paper detection section 103 have the same configuration. Further, the first processing circuit 113 and the second processing circuit 123 included in the roll paper detection section 103 have the same configuration. Therefore, in a description of FIG. 4, a description of a configuration of the second slack detection sensor 24 will be omitted, and a configuration of the first slack detection sensor 23 will be representatively described. In addition, in the description of FIG. 4, a description of the configuration of the second processing circuit 123 will be omitted, and a configuration of the first processing circuit 113 will be representatively described.

The first slack detection sensor 23 includes a light emitting sensor 23a and a light receiving sensor 23b.

The light emitting sensor 23a includes a photodiode PD and a transistor Q1 configured with an npn-type bipolar transistor. A collector of the transistor Q1 is connected to a cathode of the photodiode PD, and an emitter of the transistor Q1 is grounded. In other words, the photodiode PD and the transistor Q1 are connected in series.

When a signal having a voltage level of a “High” level is inputted to a base, the transistor Q1 performs an ON operation. In addition, the transistor Q1 performs an OFF operation when a signal having a voltage level of a “Low” level is inputted to the base. The ON operation refers to an operation of bringing the collector and the emitter of the transistor Q1 into a conductive state, and the OFF operation refers to an operation of bringing the collector and the emitter of the transistor Q1 into a disconnected state.

When the transistor Q1 is turned on, a current flows into the photodiode PD, and the photodiode PD is turned on. On the other hand, when the transistor Q1 is turned off, the photodiode PD is turned off.

The SOC 110 inputs a signal for turning on or off the transistor Q1 to the base of the transistor Q1. In other words, the SOC 110 turns on the photodiode PD by inputting a signal of the “High” level to the base of the transistor Q1. Further, the SOC 110 turns off the photodiode PD by inputting a signal of the “Low” level to the base of the transistor Q1. The SOC 110 turns on and off the photodiode PD at a predetermined cycle by inputting signals in which a voltage level alternates between the “High” level and the “Low” level at the predetermined cycle to the base of the transistor Q1.

The light receiving sensor 23b includes a phototransistor PQ and a variable resistor KR. An emitter of the phototransistor PQ and one end of the variable resistor KR are connected to a node P1. The other end of the variable resistor KR is grounded. In other words, the phototransistor PQ and the variable resistor KR are connected in series.

The phototransistor PQ receives light emitted from the photodiode PD and outputs a current corresponding to a received light amount (hereinafter, referred to as “received light current”). When the received light current flows into the variable resistor KR, a voltage corresponding to the received light current is generated at the node P1. At the detection position T1, the received light amount by the phototransistor PQ differs depending on the presence and absence of the transport roll paper RH. Therefore, the voltage corresponding to the received light current generated at the node P1 differs depending on the presence and absence of the transport roll paper RH at the detection position T1. Accordingly, the voltage generated at the node P1 corresponds to a detection voltage corresponding to the presence or absence of the transport roll paper RH at the detection position T1. The detection voltage generated at the node P1 is inputted to the first processing circuit 113.

The first processing circuit 113 includes a high-pass filter circuit 201, an impedance conversion circuit 202, and a voltage stabilizing circuit 203.

The high-pass filter circuit 201 is a filter circuit that restricts passage of a predetermined low-frequency component, and is configured with a capacitor C1 and a resistor R1. One end of the capacitor C1 is connected to the node P1 of the light receiving sensor 23b of the first slack detection sensor 23, and the other end thereof is connected to one end of the resistor R1 at a node P2. The one end of the resistor R1 is connected to the node P2, and the other end thereof is connected to a node P3 of the voltage stabilizing circuit 203.

The high-pass filter circuit 201, configured with the resistor R1 and the capacitor C1, defines based on a resistance value of the resistor R1 and capacitance of the capacitor C1, a predetermined range of frequencies for which passage is restricted. In other words, the high-pass filter circuit 201, configured with the resistor R1 and the capacitor C1, restricts passage of a component having a frequency equal to or lower than a frequency defined based on the resistance value of the resistor R1 and the capacitance of the capacitor C1. On the other hand, a component exceeding this frequency is passed. Specifically, the SOC 110 passes a component corresponding to a frequency of input signals for turning on and off the photodiode PD at a predetermined cycle.

Since the one end of the capacitor C1 is connected to the node P1, a detection voltage of the first slack detection sensor 23 is inputted to the high-pass filter circuit 201. Then, the high-pass filter circuit 201 outputs a detection voltage obtained by removing a component equal to or lower than a frequency based on the resistance value of the resistor R1 and the capacitance of the capacitor C1 to the impedance conversion circuit 202.

The impedance conversion circuit 202 includes an operational amplifier OP. A non-inverting input terminal (+) of the operational amplifier OP is connected to the high-pass filter circuit 201. More specifically, the non-inverting input terminal (+) of the operational amplifier OP is connected to the node P2 where the capacitor C1 and the resistor R1 are connected. An output terminal ST of the operational amplifier OP is negatively fed back to an inverting input terminal (−) of the operational amplifier OP. Further, the output terminal ST of the operational amplifier OP is connected to the ADC 133.

The operational amplifier OP has high input impedance, low output impedance, and an amplification factor of “1”. Therefore, the operational amplifier OP functions as a voltage follower, and performs impedance conversion on a detection voltage inputted from the high-pass filter circuit 201. In general, it is known that when a signal (including a voltage) flowing in a transmission path has high impedance, noise resistance is deteriorated and noise is easily mixed to the signal (easily superimposed). By providing the operational amplifier OP to function as the voltage follower, the impedance conversion circuit 202 can reduce impedance of a detection voltage outputted by the first processing circuit 113 to the SOC 110. Accordingly, the impedance conversion circuit 202 can prevent the deterioration in noise resistance of the detection voltage outputted to the SOC 110.

The voltage stabilizing circuit 203 includes the resistor R1, a resistor R2, a resistor R3, and a capacitor C2. The one end of the resistor R1 is connected to the node P2, and the other end thereof is connected to the node P3. One end of the resistor R2 is connected to the node P3, and a voltage is applied to the other end thereof. One end of the resistor R3 is connected to the node P3, and the other end thereof is grounded. One end of the capacitor C2 is connected to the node P3, and the other end thereof is grounded. As shown in FIG. 4, the voltage stabilizing circuit 203 is provided in the first processing circuit 113 on an input side where a detection voltage is inputted to the impedance conversion circuit 202.

The operational amplifier OP is provided in order to prevent the deterioration in noise resistance of the detection voltage, thus a leakage current is generated from the non-inverting input terminal (+) of the operational amplifier OP toward the capacitor C1. When the leakage current is generated, a voltage between the node P2 and the non-inverting input terminal (+) of the operational amplifier OP changes upward, and accordingly, the detection voltage changes. Therefore, the first processing circuit 113 includes the voltage stabilizing circuit 203 between the high-pass filter circuit 201 and an input side of the impedance conversion circuit 202. Thus, the leakage current generated in the non-inverting input terminal (+) of the operational amplifier OP is released to the voltage stabilizing circuit 203, and the voltage between the node P2 and the non-inverting input terminal (+) of the operational amplifier OP is made stabilized, and is prevented from being changed upward. Accordingly, the voltage stabilizing circuit 203 prevents a detection voltage inputted to the SOC 110 from being changed.

Next, an operation of the printing apparatus 1 including the roll paper detection section 103 having the above-described configuration will be described.

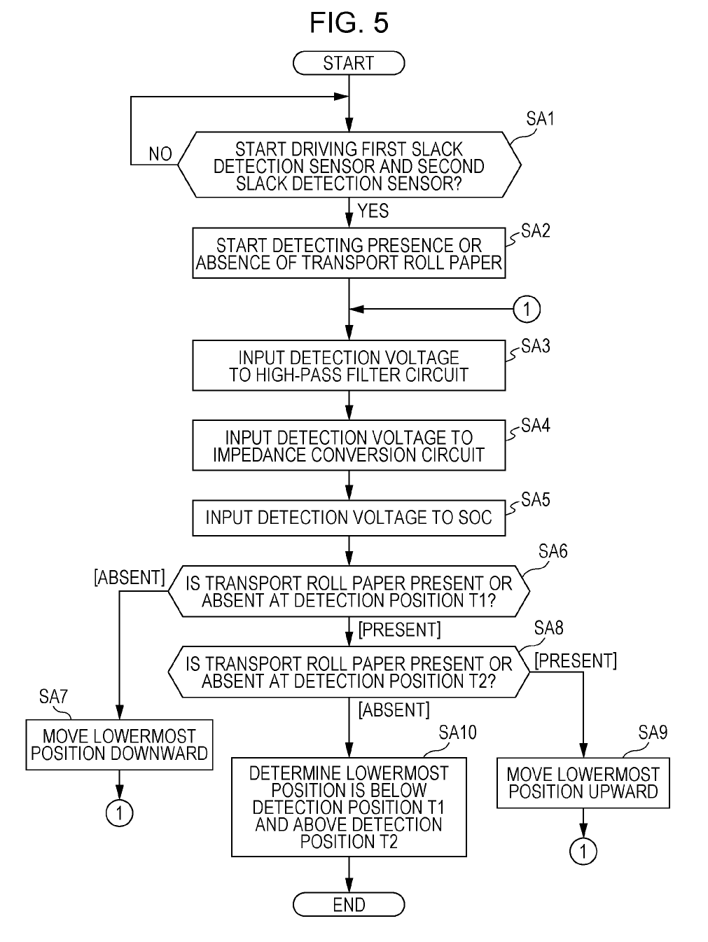

FIG. 5 is a flowchart showing the operation of the printing apparatus 1.

As described above, in the embodiment, the first slack detection sensor 23 and the second slack detection sensor 24 included in the roll paper detection section 103 have the same configuration, and the first processing circuit 113 and the second processing circuit 123 have the same configuration. For this reason, in a description of FIG. 5, as for operations common to the same configurations, descriptions of the operations for the second slack detection sensor 24 and the second processing circuit 123 will be omitted, and the operations for the first slack detection sensor 23 and the first processing circuit 113 will be representatively described.

The SOC 110 of the printing apparatus 1 determines whether or not to start driving the first slack detection sensor 23 and the second slack detection sensor 24 (Step SA1). For example, when power is supplied to the printing apparatus 1, the SOC 110 determines to start driving the first slack detection sensor 23 and the second slack detection sensor 24 using this power supply as a trigger (Step SA1: YES).

When the SOC 110 determines to start driving the first slack detection sensor 23 and the second slack detection sensor 24 (Step SA1: YES), the SOC 110 inputs signals in which a voltage level alternates between the “High” level and the “Low” level at a predetermined cycle to the first slack detection sensor 23 and the second slack detection sensor 24. Thus, the first slack detection sensor 23 and the second slack detection sensor 24 are driven at the predetermined cycle to start detecting presence or absence of the transport roll paper RH (Step SA2). In addition, when the first slack detection sensor 23 detects the presence or absence of the transport roll paper RH, the first slack detection sensor 23 outputs a detection voltage corresponding to the presence or absence of the transport roll paper RH, and also when the second slack detection sensor 24 detects the presence or absence of the transport roll paper RH, the second slack detection sensor 24 outputs a detection voltage corresponding to the presence or absence of the transport roll paper RH.

When the first slack detection sensor 23 starts detecting the presence or absence of the transport roll paper RH, the first slack detection sensor 23 inputs a detection voltage corresponding to the presence or absence of the transport roll paper RH to the high-pass filter circuit 201 of the first processing circuit 113 (Step SA3). A voltage value of the detection voltage that the first slack detection sensor 23 inputs to the high-pass filter circuit 201 differs depending on the presence or absence of the transport roll paper RH at the detection position T1. For example, a voltage value of the detection voltage when the transport roll paper RH is absent at the detection position T1 is higher than a voltage value of the detection voltage when the transport roll paper RH is present. This is because a received light amount by the phototransistor PQ is larger than an amount when the transport roll paper RH is present at the detection position T1. On the other hand, a voltage value of the detection voltage when the transport roll paper RH is present at the detection position T1 is lower than a voltage value of the detection voltage when the transport roll paper RH is absent. This is because the received light amount by the phototransistor PQ is smaller than the amount when the transport roll paper RH is absent at the detection position T1. Note that the same applies to a detection voltage outputted from the second slack detection sensor 24.

When a detection voltage is inputted from the first slack detection sensor 23, the high-pass filter circuit 201, configured with the resistor R1 and the capacitor C1, inputs a detection voltage obtained by removing a component equal to or lower than a frequency based on the resistance value of the resistor R1 and the capacitance of the capacitor C1 to the non-inverting input terminal (+) of the operational amplifier OP of the impedance conversion circuit 202 (Step SA4).

Next, when the high-pass filter circuit 201 inputs the detection voltage to the impedance conversion circuit 202, the impedance conversion circuit 202 outputs the detection voltage for which impedance is reduced to the SOC 110 via the ADC 133 (Step SA5).

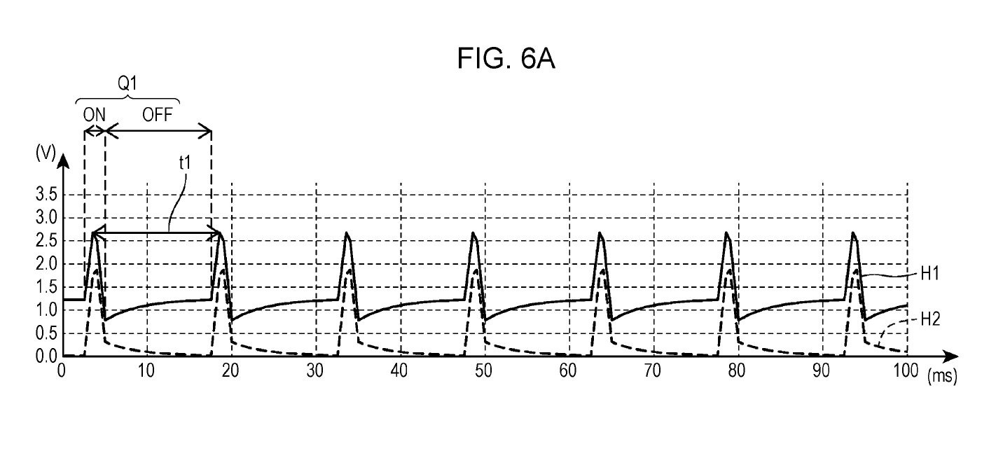

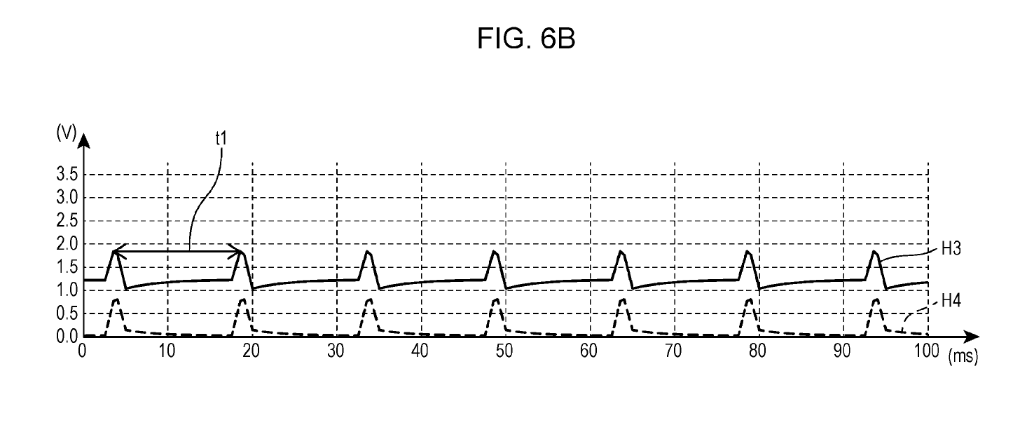

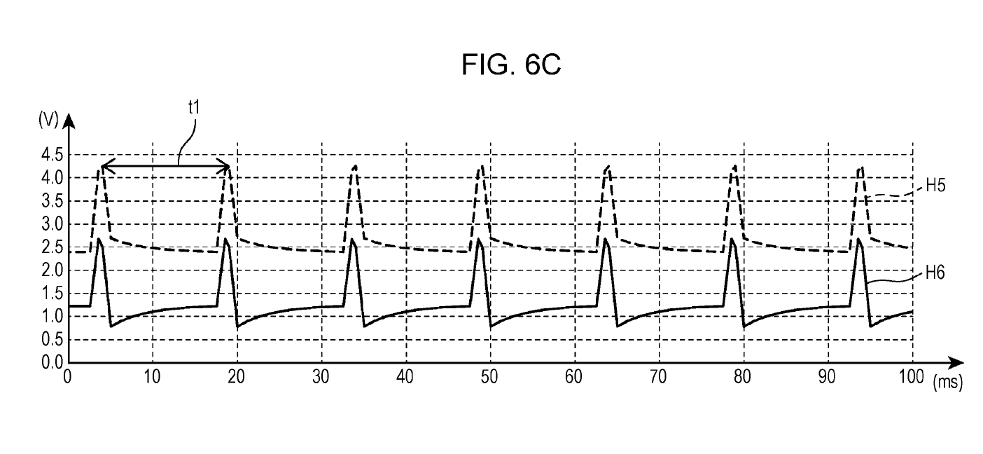

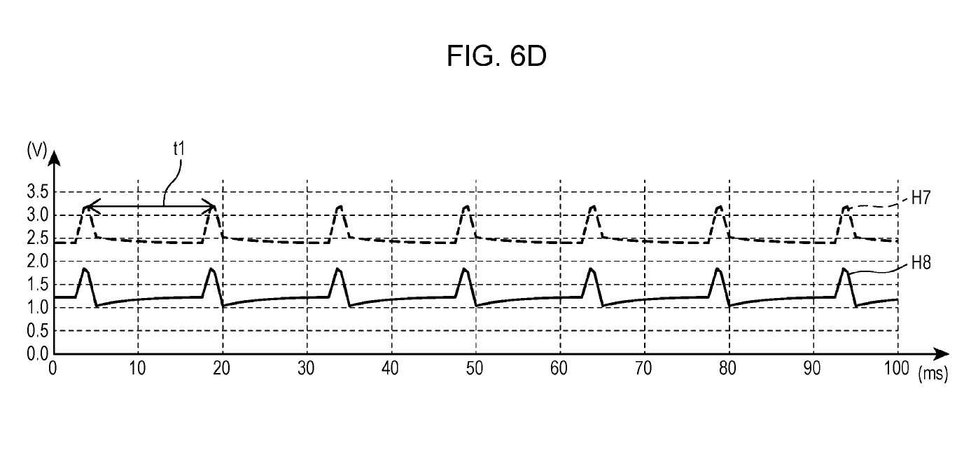

Each of FIG. 6A to FIG. 6D is a diagram illustrating an example of a simulation result. A vertical axis of each of FIG. 6A to FIG. 6D shows a voltage value of a detection voltage, and a unit thereof is volt (Volt). In addition, a horizontal axis of each of FIG. 6A to FIG. 6D shows a time, and a unit thereof is millisecond (msec).

FIG. 6A shows simulation results of detection voltages at points A, B, and C shown in FIG. 4 when there is no influence of disturbance light and the transport roll paper RH is absent at the detection position T1. In addition, FIG. 6B shows simulation results of the detection voltages at the points A, B, and C shown in FIG. 4 when there is no influence of disturbance light and the transport roll paper RH is present at the detection position T1. In addition, FIG. 6C shows simulation results of the detection voltages at the points A, B and C shown in FIG. 4 when there is an influence of disturbance light and the transport roll paper RH is absent at the detection position T1. In addition, FIG. 6D shows simulation results of the detection voltages at the points A, B, and C shown in FIG. 4 when there is the influence of disturbance light and the transport roll paper RH is present at the detection position T1. Note that the influence of disturbance light indicates that a voltage based on disturbance light is superimposed on a detection voltage.

The point A shown in FIG. 4 shows a point between the first slack detection sensor 23 and the high-pass filter circuit 201. The point B shown in FIG. 4 shows a point between the high-pass filter circuit 201 and the impedance conversion circuit 202. The point C shown in FIG. 4 shows a point between the impedance conversion circuit 202 and the SOC 110 (specifically, between the impedance conversion circuit 202 and the ADC 133).

Each description of FIG. 6A to FIG. 6D shows a case where the SOC 110 turns on and off the transistor Q1 at a cycle t1.

A waveform H1 in FIG. 6A shows waveforms of detection voltages at the point B and the point C respectively. In addition, a waveform H2 in FIG. 6A shows a waveform of a detection voltage at the point A. Note that the respective waveforms of the detection voltages at the point B and the point C overlap in FIG. 6A because the impedance conversion circuit 202 does not perform voltage conversion. Further, a difference between a voltage value in the waveform H2 and a voltage value in the waveform H1 is caused by superimposing divided voltages at the node P3 of the voltage stabilizing circuit 203.

As shown in FIG. 6A, the waveform H1 is a waveform having a peak of about 2.6 volts (V) with the interval of cycle t1, and the waveform H2 is a waveform having a peak of about 1.8 volts (V) with the interval of cycle t1. This cycle t1 is a cycle at which the SOC 110 turns on or off the transistor Q1, and is a cycle at which the first slack detection sensor 23 and the second slack detection sensor 24 are turned on.

A waveform H3 of FIG. 6B shows waveforms of detection voltages at the point B and the point C respectively. In addition, a waveform H4 in FIG. 6B shows a waveform of a detection voltage at the point A. Also in FIG. 6B, for the same reason as in FIG. 6A, the respective waveforms of the detection voltages of the point B and the point C overlap. Also in FIG. 6B, for the same reason as in FIG. 6A, the respective voltage values of the waveform H3 and the waveform H4 are different.

As shown in FIG. 6B, the waveform H3 is a waveform having a peak of about 1.8 volts (V) with the interval of cycle t1, and the waveform H4 is a waveform having a peak of about 0.7 volts (V) with the interval of cycle t1.

As is apparent in comparison with FIG. 6B and FIG. 6A, when the transport roll paper RH is present at the detection position T1, since the received light amount by the phototransistor PQ decreases, a voltage value of a detection voltage of FIG. 6B becomes lower than a voltage value of a detection voltage of FIG. 6A. In FIG. 6A, a detection voltage obtained by the SOC 110 as a digital value is a detection voltage of the waveform H1, and in FIG. 6B, a detection voltage obtained by the SOC 110 as a digital value is a detection voltage of the waveform H3. For this reason, in FIG. 6A and FIG. 6B, the SOC 110 can determine, for example, that the transport roll paper RH is present at the detection position T1 when a peak of detection voltage is higher than 2.2 volts and can determine that the transport roll paper RH is absent at the detection position T1 when the peak of detection voltage is lower than 2.2 volts, using a medium determination threshold value indicating 2.2 volts (V).

A waveform H5 in FIG. 6C shows a waveform of a detection voltage at the point A. In addition, a waveform H6 of FIG. 6C shows waveforms of detection voltages at the point B and the point C respectively. Also in FIG. 6C, for the same reason as in FIG. 6A, the respective waveforms of the detection voltages of the point B and the point C overlap.

As shown in FIG. 6C, the waveform H5 is a waveform having a peak of about 4.2 volts (V) with the interval of cycle t1, and the waveform H6 is a waveform having a peak of about 2.6 volts (V) with the interval of cycle t1.

As is apparent in comparison with FIG. 6C and FIG. 6A, when there is an influence of disturbance light, a voltage of about 1.6 volts (V) is always superimposed on a detection voltage when there is no disturbance light for a detection voltage at the point A. In addition, a reason why a voltage such as about 1.6 volts (V) is superimposed on the detection voltage when there is the disturbance light is that the phototransistor PQ receives a certain amount of light regardless of whether the photodiode PD is turned on or off in an environment where there is the disturbance light.

As is apparent in comparison with FIG. 6C and FIG. 6A, detection voltages at the point B and the point C when there is the influence of disturbance light are approximate or coincident with detection voltages at the point B and the point C when there is no disturbance light respectively. This is because a voltage based on disturbance light is removed by the high-pass filter circuit 201. A frequency of the cycle t1 at which the SOC 110 turns on or off the transistor Q1 is high due to a time constant defined by the resistance value of the resistor R1 and the capacitance value of the capacitor C1 in the high-pass filter circuit 201. Conversely, the high-pass filter circuit 201 is configured to restrict passage of a component having a frequency lower than the frequency of the cycle t1 due to the time constant defined by the resistance value of the resistor R1 and the capacitance value of the capacitor C1. Therefore, a component having a frequency equal to or higher than the frequency of the cycle t1 passes. Specifically in detail, a detection voltage outputted from the first slack detection sensor 23 forms an AC waveform having a high frequency because the transistor Q1 is turned on or off at the cycle t1. On the other hand, in an environment where there is disturbance light, the phototransistor PQ always receives a certain amount of light regardless of whether the photodiode PD is turned on or off. Therefore, a voltage based on disturbance light forms a DC waveform. Therefore, even when the voltage based on disturbance light is superimposed on the detection voltage, a DC component having a low frequency due to disturbance light is removed by the high-pass filter circuit 201, and an AC component having a high frequency including a component useful for determination passes, thus a voltage based on disturbance light is not included in the detection voltage that has passed through the high-pass filter circuit 201. From the above, as shown by the waveform H6 of FIG. 6C and the waveform H1 of FIG. 6A, the detection voltages at the point B and the point C when there is the influence of disturbance light are approximate or coincident with the detection voltages at the point B and the point C when there is no disturbance light respectively.

A waveform H7 of FIG. 6D shows a waveform of a detection voltage at the point A. In addition, a waveform H8 of FIG. 6D shows waveforms of detection voltages at the point B and the point C respectively. Also in FIG. 6D, for the same reason as in FIG. 6A, the respective waveforms of the detection voltages of the point B and the point C overlap.

As shown in FIG. 6D, the waveform H7 is a waveform having a peak of about 3.2 volts (V) with the interval of cycle t1, and the waveform H8 is a waveform having a peak of about 1.8 volts (V) with the interval of cycle t1.

As is apparent in comparison with FIG. 6D and FIG. 6B, when there is the influence of disturbance light, a voltage at the point A is a detection voltage on which a voltage of about 1.4 volts (V) is superimposed when there is no disturbance light.

As is apparent in comparison with FIG. 6D and FIG. 6B, the detection voltages at the point B and the point C when there is the influence of disturbance light are approximate or coincident with the detection voltages at the point B and the point C when there is no disturbance light respectively. This is because, as described above, the voltage based on disturbance light is removed by the high-pass filter circuit 201.

When there is the disturbance light, in FIG. 6C, a detection voltage obtained by the SOC 110 as a digital value is a detection voltage of the waveform H6, and in FIG. 6D, a detection voltage obtained by the SOC 110 as a digital value is a detection voltage of the waveform H8. As described above, the waveform H6 is approximate or coincident with the waveform H1, and the waveform H8 is approximate or coincident with the waveform H3. Therefore, even in the environment where there is the disturbance light, the voltage based on disturbance light is removed by the high-pass filter circuit 201, thus the SOC 110 can determine the presence or absence of the transport roll paper RH at the detection position T1 using a medium determination threshold value used when there is no influence of disturbance light.

By setting a frequency to be passed to be equal to or higher than a frequency of the detection voltage outputted from the first slack detection sensor 23 using the time constant defined based on the resistance value of the resistor R1 and the capacitance of the capacitor C1 of the high-pass filter circuit 201, the high-pass filter circuit 201 can remove the voltage based on disturbance light from the detection voltage when the voltage based on disturbance light forms an AC waveform lower than the frequency of the detection voltage even when the voltage based on disturbance light does not form a DC waveform. Further, the high-pass filter circuit 201 can also remove a voltage based on noise generated on a predetermined substrate from a detection voltage, for example, and the voltage is not limited to a voltage based on disturbance light as long as the voltage forms an AC waveform lower than a frequency of the detection voltage.

Returning to a description of the flowchart shown in FIG. 5, when a detection voltage is inputted, the SOC 110 determines presence or absence of the transport roll paper RH at the detection position T1 based on a medium determination threshold value stored in the memory 120 (Step SA6). When the SOC 110 determines that transport roll paper RH is absent at the detection position T1 (Step SA6: “Absent”), the SOC 110 rotates the delivery motor 111 in the rotation direction KH and moves the lowermost position U1 of the transport roll paper RH downward (Step SA7). Then, the printing apparatus 1 returns the processing to Step SA3 and again detects the presence or absence of the transport roll paper RH at the detection position T1 and the detection position T2.

On the other hand, when the SOC 110 determines that the transport roll paper RH is present at the detection position T1 (Step SA6: “Present”), the SOC 110 determines the presence or absence of the transport roll paper RH at the detection position T2 based on the detection voltage inputted from the second slack detection sensor 24 via the second processing circuit 123 and the medium determination threshold value (Step SA8).

When the SOC 110 determines that the transport roll paper RH is present at the detection position T2 (Step SA8: “Present”), the SOC 110 rotates the delivery motor 111 in an opposite direction of the rotation direction KH, and transports the transport roll paper RH so as to move the lowermost position U1 of the transport roll paper RH upward (Step SA9). Then, the printing apparatus 1 returns the processing to Step SA3 and again detects the presence or absence of the transport roll paper RH at the detection position T1 and the detection position T2.

On the other hand, when the SOC 110 determines that transport roll paper RH is absent at the detection position T2 (Step SA8: “Absent”), the SOC 110 determines that the lowermost position U1 of the transport roll paper RH is below the detection position T1 and above the detection position T2 (Step SA10), and ends the processing.

As described above, the SOC 110 compares the detection voltage that has passed through the high-pass filter circuit 201 with the medium determination threshold value, and determines the presence or absence of the transport roll paper RH at the detection position T1 and the presence or absence of the transport roll paper RH at the detection position T2. Therefore, the printing apparatus 1 can accurately detect the presence or absence of the transport roll paper RH at the detection position T1 and the detection position T2 by the first slack detection sensor 23 and the second slack detection sensor 24 respectively, while preventing the influence of disturbance light. In addition, since the SOC 110 controls movement of the lowermost position U1 based on the presence or absence of the transport roll paper RH detected accurately, the lowermost position U1 can be reliably positioned below the detection position T1 and above the detection position T2. Thus, the SOC 110 may reliably suppress occurrence of the empty transport in the transport roller 18 and the driven roller 19.

Further, the impedance conversion circuit 202 is provided between the high-pass filter circuit 201 and the SOC 110. Therefore, it is possible to prevent the deterioration in noise resistance of the detection voltage that has passed through the high-pass filter circuit 201, and the printing apparatus 1 can accurately detect the presence or absence of the transport roll paper RH at the detection position T1 and the detection position T2 by the first slack detection sensor 23 and the second slack detection sensor 24 respectively.

Further, the voltage stabilizing circuit 203 is provided on an input side of the detection voltage in the impedance conversion circuit 202. Accordingly, it is possible to prevent the detection voltage from being changed by a leakage current generated on the input side of the impedance conversion circuit 202, and the printing apparatus 1 can accurately detect the presence or absence of the transport roll paper RH at the detection position T1 and the detection position T2 by the first slack detection sensor 23 and the second slack detection sensor 24 respectively.

In the above description, the configuration of the roll paper detection section 103 (in particular, the first processing circuit 113 and the second processing circuit 123) that accurately detects the presence or absence of the transport roll paper RH by the first slack detection sensor 23 and the second slack detection sensor 24 has been described. However, the label detection section 104 may have the same configuration as the roll paper detection section 103. Thus, the printing apparatus 1 may accurately detect the presence or absence of the label LB on the mount DS by the label detection section 104. Hereinafter, this will be described.

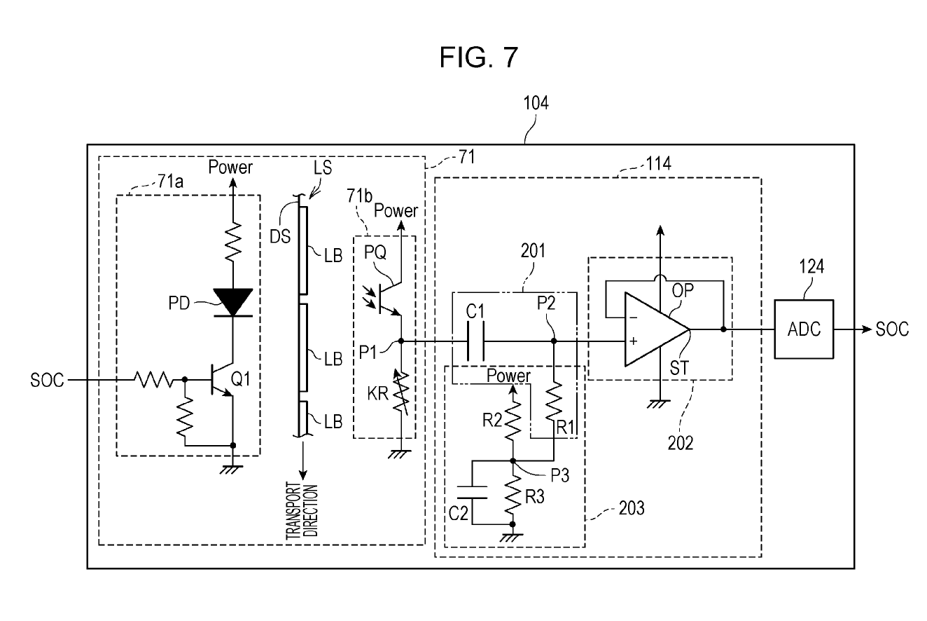

FIG. 7 is a diagram showing a configuration of the label detection section 104.

In a description of FIG. 7, the same constituent elements as the roll paper detection section 103 shown in FIG. 4 are assigned the same reference numerals, and detailed descriptions thereof will be omitted.

As shown in FIG. 7, the label detection sensor 71 included in the label detection section 104 includes the light emitting sensor 71a and the light receiving sensor 71b. The light emitting sensor 71a has the same configuration as the light emitting sensor 23a shown in FIG. 4. Additionally, the light receiving sensor 71b has the same configuration as the light receiving sensor 23b shown in FIG. 4.

Further, the third processing circuit 114 included in the label detection section 104 has the same configuration as the first processing circuit 113 and the second processing circuit 123. In other words, the third processing circuit 114 includes the high-pass filter circuit 201, the impedance conversion circuit 202, and the voltage stabilizing circuit 203.

Next, an operation of the printing apparatus 1 including the label detection section 104 having a configuration shown in FIG. 7 will be described.

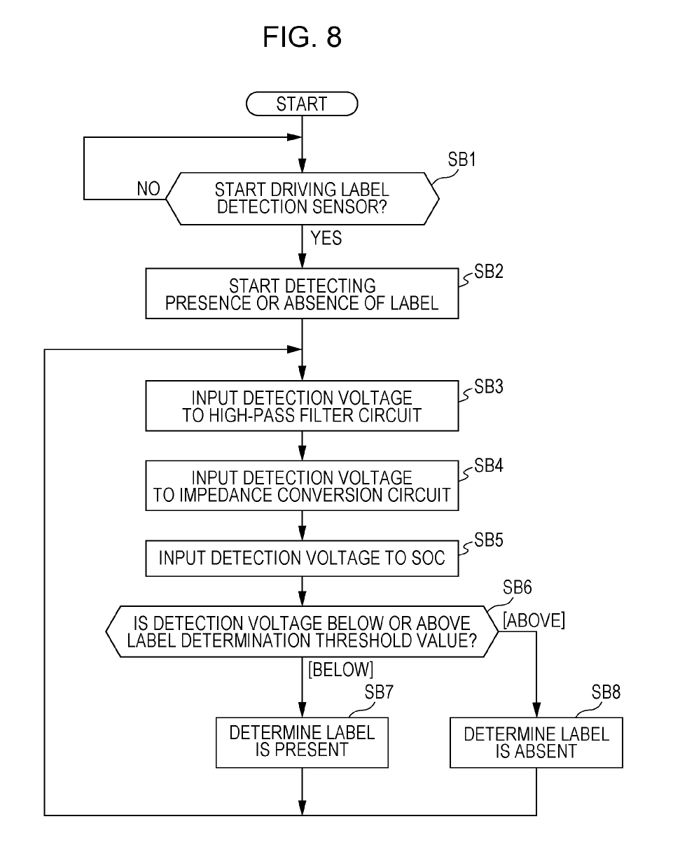

FIG. 8 is a flowchart showing the operation of the printing apparatus 1.

The SOC 110 of the printing apparatus 1 determines whether or not to start driving the label detection sensor 71 (Step SB1). For example, when power is supplied to the printing apparatus 1, the SOC 110 determines to start driving the label detection sensor 71 using this power supply as a trigger (Step SB1: YES).

When the SOC 110 determines to start driving the label detection sensor 71 (Step SB1: YES), the SOC 110 inputs signals in which a voltage level alternates between the “High” level and the “Low” level at a predetermined cycle to the label detection sensor 71. Thus, the label detection sensor 71 is driven at the predetermined cycle and starts detecting presence or absence of the label LB on the mount DS (Step SB2). When the label detection sensor 71 detects the presence or absence of the label LB, the label detection sensor 71 outputs a detection voltage corresponding to presence or absence of the label LB at the detection position P.

When the detection of the presence or absence of the label LB on the mount DS is started, the label detection sensor 71 inputs the detection voltage corresponding to the presence or absence of the label LB to the high-pass filter circuit 201 of the third processing circuit 114 (Step SB3). A voltage value of the detection voltage that the label detection sensor 71 inputs to the high-pass filter circuit 201 differs depending on which of the mount portion DSa and the label portion LBa is positioned at the detection position P. For example, a voltage value of the detection voltage when the mount portion DSa is at the detection position P is higher than when the label portion LBa is positioned at the detection position P. This is because the label LB is absent on the mount portion DSa and the received light amount by the phototransistor PQ is larger than when the label LB is present. On the other hand, when the label portion LBa is positioned at the detection position P, a voltage value of the detection voltage is lower than when the mount portion DSa is positioned at the detection position P. This is because on the label portion LBa of the mount DS the label LB is present, and the received light amount by the phototransistor PQ is smaller than when the label LB is absent.

When the detection voltage is inputted from the label detection sensor 71, the high-pass filter circuit 201, configured with the resistor R1 and the capacitor C1, inputs a detection voltage obtained by removing a component equal to or lower than a frequency based on the resistance value of the resistor R1 and the capacitance of the capacitor C1 to the non-inverting input terminal (+) of the operational amplifier OP of the impedance conversion circuit 202 (Step SB4).

Next, when the high-pass filter circuit 201 inputs the detection voltage to the impedance conversion circuit 202, the impedance conversion circuit 202 outputs the detection voltage for which impedance is reduced to the SOC 110 via the ADC 133 (Step SB5).

When the detection voltage is inputted, the SOC 110 determines whether the inputted detection voltage is lower than or higher than the label determination threshold value stored in the memory 120 (Step SB6). As the label determination threshold value, for example, an intermediate value between a voltage value of a detection voltage when the mount portion DSa is positioned at the detection position P and a voltage value of a detection voltage when the label portion LBa is positioned at the detection position P may be cited.

When the SOC 110 determines that the detection voltage falls below the label determination threshold value (Step SB6: “Below”), the SOC 110 determines that the label LB is present at the detection position P (Step SB7). On the other hand, when the SOC 110 determines that the detection voltage exceeds the label determination threshold value (Step SB6: “Above”), the SOC 110 determines that the label LB is absent at the detection position P (Step SB8).

In this way, the SOC 110 compares the detection voltage that has passed through the high-pass filter circuit 201 with the label determination threshold value, and determines the presence or absence of the label LB on the mount DS. Therefore, the printing apparatus 1 can accurately detect the label LB on the mount DS by the label detection sensor 71 while preventing the influence of disturbance light (e.g., erroneous determination of the presence or absence of the label LB). Accordingly, the SOC 110 can accurately identify the mount portion DSa and the label portion LBa in the label sheet LS, and can accurately control a print position, for example.

Also, in the label detection section 104, the impedance conversion circuit 202 is provided between the high-pass filter circuit 201 and the SOC 110. Therefore, it is possible to prevent the deterioration in noise resistance of the detection voltage that has passed through the high-pass filter circuit 201, and the printing apparatus 1 can accurately detect the presence or absence of the label LB on the mount DS by the label detection sensor 71.

Also, in the label detection section 104, the voltage stabilizing circuit 203 is provided on the input side of the detection voltage in the impedance conversion circuit 202. Therefore, it is possible to prevent the detection voltage from being changed by the leakage current generated on the input side of the impedance conversion circuit 202, and the printing apparatus 1 can accurately detect the presence or absence of the label LB on the mount DS by the label detection sensor 71.

### Variations

Next, variations will be described.

The variations are examples applicable to the roll paper detection section 103 and the label detection section 104. Hereinafter, a variation on the roll paper detection section 103 will be representatively described.

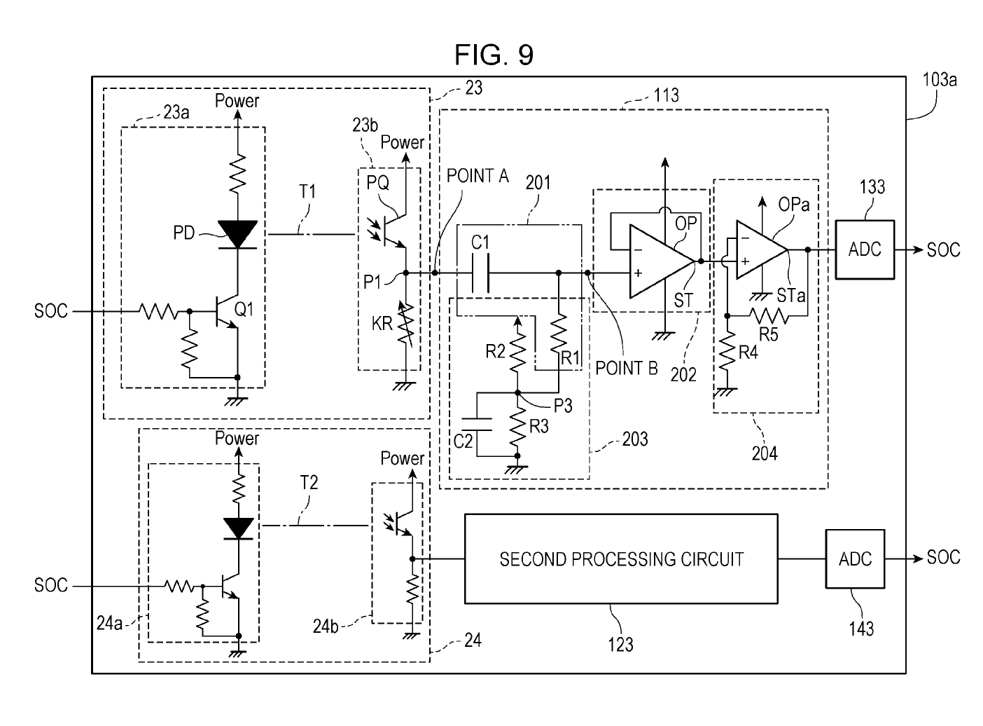

FIG. 9 is a diagram showing a configuration of a roll paper detection section 103a according to the variation.

In a description of FIG. 9, the same constituent elements as the roll paper detection section 103 shown in FIG. 4 are assigned the same reference numerals, and detailed descriptions thereof will be omitted.

Note that, similarly to the description of FIG. 4, also in the description of FIG. 9, the first processing circuit 113 and the second processing circuit 123 included in the roll paper detection section 103a have the same configuration. Accordingly, also in the description of FIG. 9, a description of a configuration of the second processing circuit 123 will be omitted, and a configuration of the first processing circuit 113 will be representatively described.

As is apparent in comparison with FIG. 4 and FIG. 9, the first processing circuit 113 according to the variation includes an amplifier circuit 204 between the impedance conversion circuit 202 and the SOC 110.

The amplifier circuit 204 includes an operational amplifier OPa, a resistor R4, and a resistor R5.

A non-inverting input terminal (+) of the operational amplifier OPa is connected to the output terminal ST of the operational amplifier OP of the impedance conversion circuit 202. One end of the resistor R5 and one end of the resistor R4 are connected to an inverting input terminal (−) of the operational amplifier OPa. The other end of the resistor R5 is connected to an output terminal STa of the operational amplifier OPa. Further, the ADC 133 is connected to the output terminal STa of the operational amplifier OPa.

The amplifier circuit 204 amplifies a detection voltage outputted from the impedance conversion circuit 202 with an amplification factor based on the resistor R4 and the resistor R5 by the operational amplifier OPa, and outputs the amplified detection voltage to the SOC 110 via the ADC 133.

As in the variation, by providing the amplifier circuit 204 between the impedance conversion circuit 202 and the SOC 110, the SOC 110 can obtain the amplified detection voltage. Therefore, in the detection position T1 and the detection position T2, a difference between the detection voltage when the transport roll paper RH is present and the detection voltage when the transport roll paper RH is absent can be made remarkable, and the SOC 110 can determine the presence or absence of the transport roll paper RH at the detection position T1 and the detection position T2 more accurately using a medium determination threshold value. With this effect, the SOC 110 can more reliably suppress occurrence of empty transport in the transport roller 18 and the driven roller 19.

As described above, the printing apparatus 1 includes the transport section 101 that transports the transport roll paper RH as a print medium (medium), the first slack detection sensor 23 (optical sensor) that drives at a predetermined cycle, the second slack detection sensor 24 (optical sensor), the high-pass filter circuit 201 to which the detection voltages of the first slack detection sensor 23 and the second slack detection sensor 24 are inputted, and the SOC 110 (control circuit) that determines presence or absence of the transport roll paper RH at the detection position T1 and the detection position T2 by comparing a detection voltage that has passed through the high-pass filter circuit 201 with the medium determination threshold value (predetermined threshold value). Further, the printing apparatus 1 includes the label detection sensor 71 (optical sensor) that drives at a predetermined cycle, the high-pass filter circuit 201 to which a detection voltage of the label detection sensor 71 is inputted, and the SOC 110 (control circuit) that compares the detection voltage which has passed through the high-pass filter circuit 201 with a label determination threshold value (predetermined threshold value) and determines a label (mark) attached to the label sheet LS as a print medium.

According to this configuration, the detection voltage that has passed through the high-pass filter circuit 201 is compared with the medium determination threshold value, and the presence or absence of the transport roll paper RH at the detection position T1 and the detection position T2 is determined, and the detection voltage that has passed through the high-pass filter circuit 201 is compared with the label determination threshold value to determine the label on the label sheet LS, thus detection on a print medium can be performed accurately while preventing an influence of disturbance light. More specifically, the printing apparatus 1 can accurately detect the presence or absence of the transport roll paper RH at the detection position T1 and the detection position T2 by the first slack detection sensor 23 and the second slack detection sensor 24 respectively, while preventing erroneous determination due to disturbance light. Further, the printing apparatus 1 prevents the erroneous determination due to disturbance light and can accurately detect the label LB attached to the label sheet LS by the label detection sensor 71.

Further, the printing apparatus 1 includes the impedance conversion circuit 202 between the high-pass filter circuit 201 and the SOC 110.

According to this configuration, it is possible to prevent deterioration in noise resistance of the detection voltage that has passed through the high-pass filter circuit 201, and the printing apparatus 1 can accurately detect the presence or absence of the transport roll paper RH at the detection position T1 and the detection position T2 by the first slack detection sensor 23 and the second slack detection sensor 24 respectively. Further, the printing apparatus 1 can accurately detect the label LB attached to the label sheet LS by the label detection sensor 71.

Further, the printing apparatus 1 includes the voltage stabilizing circuit 203 on an input side of the detection voltage in the impedance conversion circuit 202.

According to this configuration, it is possible to prevent the detection voltage from being changed by a leakage current generated on the input side of the impedance conversion circuit 202, and the printing apparatus 1 can accurately detect the presence or absence of the transport roll paper RH at the detection position T1 and the detection position T2 by the first slack detection sensor 23 and the second slack detection sensor 24 respectively. Further, the printing apparatus 1 can accurately detect the label LB attached to the label sheet LS by the label detection sensor 71.

Further, the printing apparatus 1 includes the amplifier circuit 204 between the impedance conversion circuit 202 and the SOC 110.

According to this configuration, the printing apparatus 1 includes the amplifier circuit 204 between the impedance conversion circuit 202 and the SOC 110, thus a difference in the detection voltages can be made remarkable. More specifically, at the detection position T1 and the detection position T2, the printing apparatus 1 can make a difference between a detection voltage when the transport roll paper RH is present and a detection voltage when the transport roll paper RH is absent remarkable, and can detect the presence or absence of the transport roll paper RH at the detection position T1 and the detection position T2 more accurately. Further, the printing apparatus 1 can make a difference between a detection voltage when the label LB is present and a detection voltage when the label LB is absent at the detection position P remarkable, and can detect the presence or absence of the label LB at the detection position P more accurately.

In addition, a print medium of the embodiment is the label sheet LS that is formed by attaching the labels LB to the mount DS at a predetermined interval. The SOC 110 compares the detection voltage that has passed through the high-pass filter circuit 201 with the label determination threshold value (predetermined threshold value), and determines presence or absence of the label LB on the mount DS.

According to this configuration, since the printing apparatus 1 compares the detection voltage that has passed through the high-pass filter circuit 201 with the label determination threshold value and determines the presence or absence of the label LB on the mount DS, it is possible to accurately detect the presence or absence of the label LB attached to the mount DS by the label detection sensor 71 while preventing the influence of disturbance light. Thus, the SOC 110 can accurately manage a printing position.

In addition, the print medium of the embodiment is the roll paper R. The SOC 110 compares the detection voltage that has passed through the high-pass filter circuit 201 with the medium determination threshold value, detects the presence or absence of the transport roll paper RH, and controls vertical movement of the transport roll paper RH.

According to this configuration, by comparing the detection voltage that has passed through the high-pass filter circuit 201 with the medium determination threshold value to determine the presence or absence of the transport roll paper RH, the printing apparatus 1 can accurately detect the presence or absence of the transport roll paper RH by the first slack detection sensor 23 and the second slack detection sensor 24 while preventing the influence of disturbance light, and accurately control the vertical movement of the transport roll paper RH. Thus, the SOC 110 can reliably suppress occurrence of the empty transport in the transport roller 18 and the driven roller 19.

Note that the above-described embodiment is merely one aspect of the invention and may be modified and applied arbitrarily within the scope of the invention.

For example, in the above-described embodiment, as optical sensors, the first slack detection sensor 23, the second slack detection sensor 24, and the label detection sensor 71 were described. However, the optical sensors are not limited thereto. For example, a black mark detection sensor for detecting a black or dark colored rectangular black mark on a back surface of the label sheet LS, or a cutout detection sensor for detecting a cutout formed on a print medium may be used.

Further, for example, in the above-described embodiment, the respective circuit configurations shown in FIG. 4, FIG. 7, and FIG. 9 are merely examples, and may be changed in such a way that the circuit elements shown in the figures are replaced by the same number or different numbers of ICs, or the like, and may be arbitrarily changed within the scope of the invention.

Further, each functional section shown in FIG. 3 shows a configuration, and a specific embodiment is not particularly limited. In other words, it is not necessary to implement hardware individually corresponding to each functional unit, and it is of course possible to be a configuration to realize functions of a plurality of functional sections by one processor executing a program. In addition, part of the functions realized by software in each of the above-described embodiments may be realized as hardware, or part of functions realized by hardware may be realized as software. Other specific detailed configuration of each section of the printing apparatus 1 may be changed without departing from the scope of the invention.

What is claimed is:

1. A printing apparatus comprising:
a transport mechanism for transporting a medium;
an optical sensor;
a high-pass filter circuit to which a detection voltage of the optical sensor is inputted; and
a control circuit which drives the optical sensor at a predetermined cycle and compares an output voltage outputted from the high-pass filter circuit with a predetermined threshold value to determine presence or absence of the medium.

2. The printing apparatus according to claim 1, wherein an impedance conversion circuit is included between the high-pass filter circuit and the control circuit.

3. The printing apparatus according to claim 2, wherein a voltage stabilizing circuit is included on an input side of the impedance conversion circuit.

4. The printing apparatus according to claim 2, wherein an amplifier circuit is included between the impedance conversion circuit and the control circuit.

5. The printing apparatus according to claim 1, wherein the medium is a label sheet that is formed by attaching labels to a mount at a predetermined interval, and
the control circuit compares the output voltage outputted from the high-pass filter circuit with the predetermined threshold value to determine presence or absence of the label on the mount.

6. The printing apparatus according to claim 1, wherein a mark is attached to the medium, and
the control circuit compares the output voltage outputted from the high-pass filter circuit with the predetermined threshold value to determine the mark attached to the medium.

7. The printing apparatus according to claim 1, wherein the control circuit compares the output voltage outputted from the high-pass filter circuit with the predetermined threshold value, detects presence or absence of the medium, and controls transport of the medium by the transport mechanism.

8. The printing apparatus according to claim 1, wherein the control circuit drives the optical sensor at a cycle for which the detection voltage is capable of passing through the high-pass filter circuit.

9. A method for controlling a printing apparatus including a transport mechanism for transporting a medium, the method comprising:
driving an optical sensor at a predetermined cycle;
inputting a detection voltage of the optical sensor to a high-pass filter circuit; and
comparing an output voltage outputted from the high-pass filter circuit with a predetermined threshold value to determine presence or absence of the medium.

10. The method for controlling a printing apparatus according to claim 9, wherein an impedance conversion circuit is included between the high-pass filter circuit and the control circuit and the output voltage is inputted thereto.

11. The method for controlling a printing apparatus according to claim 10, wherein a voltage stabilizing circuit is included on an input side of the impedance conversion circuit and the output voltage is inputted thereto.

12. The method for controlling a printing apparatus according to claim 10, wherein an amplifier circuit is included between the impedance conversion circuit and the control circuit and the output voltage is inputted thereto.

13. The method for controlling a printing apparatus according to claim 9, wherein the medium is a label sheet that is formed by attaching labels to a mount at a predetermined interval, and
the output voltage outputted from the high-pass filter circuit is compared with the predetermined threshold value to determine presence or absence of the label on the mount.

14. The method for controlling a printing apparatus according to claim 9, wherein a mark is attached to the medium, and
the output voltage outputted from the high-pass filter circuit is compared with the predetermined threshold value to determine the mark attached to the medium.

15. The method for controlling a printing apparatus according to claim 9, wherein the output voltage outputted from the high-pass filter circuit is compared with the predetermined threshold value, presence or absence of the medium is detected, and transport of the medium by the transport mechanism is controlled.

16. The printing apparatus according to claim 1, wherein the optical sensor is driven at a cycle for which the detection voltage is capable of passing through the high-pass filter circuit.
